(19) United States
(12) Patent Application Publication
(10) Pub. No.: US 2026/0019372 A1
(43) Pub. Date: Jan. 15, 2026

(54) Efficient flow aging

(71) Applicant: Mellanox Technologies, Ltd., Yokneam (IL)

(72) Inventor: Roni Bar Yanai, Even Yehuda (IL)

(21) Appl. No.: 18/766,798

(22) Filed: Jul. 9, 2024

(51) Int. Cl. H04L 47/2416; H04L 43/0876

(52) U.S. Cl. CPC H04L 47/2416; H04L 43/0876

(57) ABSTRACT

In one embodiment, a system includes an interface to send and receive packets of a plurality of network flows, and one or more circuits to track a connection status of each of the network flows, operate a flow aging process to identify idle network flows, in one stage of the flow aging process, assign first network flows of the plurality network flows having a non-terminated connection status to a waiting pool for a first time period, wherein at the end of the first time period second network flows of the first network flows have the non-terminated connection status, and third network flows of the first network flows a terminated connection status, in another stage of the flow aging process, after completion of the first time period, assign per-flow packet counters to perform packet counting of the second network flows, and release resources associated with the idle network flows.

### FIELD OF THE DISCLOSURE

The present disclosure relates to computer systems, and in particular, but not exclusively to, network flow aging.

### BACKGROUND

When a connection, such as a Transmission Control Protocol (TCP), QUIC, or Session Initiation Protocol (SIP) over User Datagram Protocol (UDP) connection, is established, resources are allocated to the connection by the end-node devices. The resources are reserved for the connection until the resources are released when the flow associated with the connection ends. The flow often ends explicitly (e.g., by receiving an RST or FIN packet for TCP) but sometimes the flow disappears leaving the connection hanging and still using resources.

### OVERVIEW

There is provided in accordance with an embodiment of the present disclosure, a system, including an interface to send and receive packets of a plurality of network flows, and one or more circuits to track a connection status of each of the network flows, operate a flow aging process to identify idle network flows of the network flows, in one stage of the flow aging process, assign first network flows of the plurality of network flows having a non-terminated connection status to a waiting pool for a first time period, wherein at the end of the first time period second network flows of the first network flows have the non-terminated connection status, and third network flows of the first network flows have a terminated connection status, in another stage of the flow aging process, after completion of the first time period, assign per-flow packet counters to perform packet counting of the second network flows, and release resources associated with the idle network flows.

Further in accordance with an embodiment of the present disclosure a number of the packets of the first network flows assigned to the waiting pool are not counted during the first time period.

Still further in accordance with an embodiment of the present disclosure the one or more circuits are to identify fourth network flows of the second network flows for which no packets have been counted by respective ones of the per-flow packet counters during a second time period starting from a time that the per-flow packet counters were assigned to perform the packet counting of the second network flows, and assign the fourth network flows to a wait-to-die pool and assign a first per-pool packet counter to perform packet counting of the fourth network flows.

Additionally in accordance with an embodiment of the present disclosure the one or more circuits are to assign only four of the fourth network flows to the wait-to-die pool.

Moreover, in accordance with an embodiment of the present disclosure the one or more circuits are to release resources associated with the fourth network flows responsively to no packets being counted in a given time period by the first per-pool packet counter assigned to perform packet counting of the fourth network flows of the wait-to-die pool.

Further in accordance with an embodiment of the present disclosure the one or more circuits are to identify at least one fifth network flow of the second network flows for which at least one packet has been counted by respective ones of the per-flow packet counters during the second time period starting from the time that the per-flow packet counters were assigned to perform the packet counting of the second network flows, and assign the at least one fifth network flow to a wait-and-watch pool and assign at least one second per-flow packet counter to perform packet counting of the at least one fifth network flow.

Still further in accordance with an embodiment of the present disclosure the one or more circuits is to release resources associated with a given flow of the at least one fifth network flow responsively to no packets being counted in a given time period by a given counter of the at least one second per-flow packet counter assigned to perform packet counting of the given flow of the at least one fifth network flow of the wait-and-watch pool.

Additionally in accordance with an embodiment of the present disclosure the one or more circuits are to identify that at least one packet has been counted by the first per-pool packet counter assigned to perform the packet counting of the fourth network flows of the wait-to-die pool, and assign additional per-flow packet counters to perform packet counting of the fourth network flows, responsively to identifying that the at least one packet has been counted by the first per-pool packet counter assigned to perform the packet counting of the fourth network flows of the wait-to-die-pool.

Moreover in accordance with an embodiment of the present disclosure the one or more circuits are to identify sixth network flows of the fourth network flows for which no packets have been counted by respective ones of the additional per-flow packet counters during a third time period starting from a time that the additional per-flow packet counters were assigned to perform the packet counting of the fourth network flows, and assign the sixth network flows to another wait-to-die pool and assign a third per-pool packet counter to perform packet counting of the sixth network flows.

Further in accordance with an embodiment of the present disclosure the one or more circuits are to identify at least one seventh network flow of the fourth network flows for which at least one packet has been counted by respective ones of the additional per-flow packet counters during the third time period starting from the time that the additional per-flow packet counters were assigned to perform the packet counting of the fourth network flows, and assign the at least one seventh network flow to a wait-and-watch pool and assign at least one per-flow fourth packet counter to perform packet counting of the at least one seventh network flow.

Still further in accordance with an embodiment of the present disclosure the first time period is between 1 and 3 seconds, and the second time period is between 1 and 5 seconds.

There is also provided in accordance with another embodiment of the present disclosure, a method, including sending and receiving packets of a plurality of network flows, tracking a connection status of each of the network flows, operating a flow aging process to identify idle network flows of the network flows, in one stage of the flow aging process, assigning first network flows of the plurality of network flows having a non-terminated connection status to a waiting pool for a first time period, wherein at the end of the first time period second network flows of the first network flows have the non-terminated connection status, and third network flows of the first network flows have a terminated connection status, in another stage of the flow aging process, after completion of the first time period, assigning per-flow packet counters to perform packet counting of the second network flows, and releasing resources associated with the idle network flows.

Additionally in accordance with an embodiment of the present disclosure a number of the packets of the first network flows assigned to the waiting pool are not counted during the first time period.

Moreover, in accordance with an embodiment of the present disclosure, the method includes identifying fourth network flows of the second network flows for which no packets have been counted by respective ones of the per-flow packet counters during a second time period starting from a time that the per-flow packet counters were assigned to perform the packet counting of the second network flows, assigning the fourth network flows to a wait-to-die pool, and assigning a first per-pool packet counter to perform packet counting of the fourth network flows.

Further in accordance with an embodiment of the present disclosure the assigning the fourth network flows includes assigning only four of the fourth network flows to the wait-to-die pool.

Still further in accordance with an embodiment of the present disclosure, the method includes releasing resources associated with the fourth network flows responsively to no packets being counted in a given time period by the first per-pool packet counter assigned to perform packet counting of the fourth network flows of the wait-to-die pool.

Additionally in accordance with an embodiment of the present disclosure, the method includes identifying at least one fifth network flow of the second network flows for which at least one packet has been counted by respective ones of the per-flow packet counters during the second time period starting from the time that the per-flow packet counters were assigned to perform the packet counting of the second network flows, assigning the at least one fifth network flow to a wait-and-watch pool, and assigning at least one second per-flow packet counter to perform packet counting of the at least one fifth network flow.

Moreover, in accordance with an embodiment of the present disclosure, the method includes releasing resources associated with a given flow of the at least one fifth network flow responsively to no packets being counted in a given time period by a given counter of the at least one second packet counter assigned to perform packet counting of the given flow of the at least one fifth network flow of the wait-and-watch pool.

Further in accordance with an embodiment of the present disclosure, the method includes identifying that at least one packet has been counted by the first per-pool packet counter assigned to perform the packet counting of the fourth network flows of the wait-to-die pool, and assigning additional per-flow packet counters to perform packet counting of the fourth network flows, responsively to identifying that the at least one packet has been counted by the first per-pool packet counter assigned to perform the packet counting of the fourth network flows of the wait-to-die-pool.

Still further in accordance with an embodiment of the present disclosure, the method includes identifying sixth network flows of the fourth network flows for which no packets have been counted by respective ones of the additional per-flow packet counters during a third time period starting from a time that the additional per-flow packet counters were assigned to perform the packet counting of the fourth network flows, assigning the sixth network flows to another wait-to-die pool, and assigning a third per-pool packet counter to perform packet counting of the sixth network flows.

Additionally in accordance with an embodiment of the present disclosure the one or more circuits are to identifying at least one seventh network flow of the fourth network flows for which at least one packet has been counted by respective ones of the additional per-flow packet counters during the third time period starting from the time that the additional per-flow packet counters were assigned to perform the packet counting of the fourth network flows, and assigning the at least one seventh network flow to a wait-and-watch pool, and assigning a fourth per-flow packet counter to perform packet counting of the at least one seventh network flow.

Moreover, in accordance with an embodiment of the present disclosure the first time period is between 1 and 3 seconds, and the second time period is between 1 and 5 seconds.

### BRIEF DESCRIPTION OF THE DRAWINGS

The present disclosure will be understood from the following detailed description, taken in conjunction with the drawings in which:

FIG. 1 is a block diagram view of a flow aging system constructed and operative in accordance with an embodiment of the present disclosure; and

FIGS. 2A-B are views of a data flow diagram illustrating an example method of operation of the system of FIG. 1.

### DESCRIPTION OF EXAMPLE EMBODIMENTS

### Examples Overview

As previously mentioned, when a connection, such as a TCP, QUIC, or SIP over UDP connection, is established, resources are allocated to the connection by the end-node devices. The resources are reserved for the connection until the resources are released when a network flow associated with the connection ends. The network flow often ends explicitly (e.g., by receiving an RST or FIN packet for TCP or other completion message such as a completion message of QUIC or a BYE message of SIP over UDP or any other protocol with explicit termination) but sometimes the network flow disappears leaving the connection hanging and still using resources.

One solution is to have counters running for each network flow (e.g., in the hardware of a network interface controller (NIC)) and software running on a host device that checks the counters periodically. This is because the software running in the host device cannot directly track the packets and therefore this task is offloaded to hardware in the NIC. The counters keep track of packets moving in either direction (being received or being sent). If the counters do not move for a given time period, this indicates that the relevant network flows have hung, and the resources can be released. However, since most of the sessions end explicitly (e.g., gracefully) the counters (especially incrementing the counters) and host processor time spent on this process is very wasteful. Another solution is to use software to track the last active time of packets leaving and entering the host and if a network flow is idle for long enough the resources reserved for that network flow are released. This solution also wastes resources.

For flows which do not end gracefully, such as UDP, it is desirable not to waste resources to maintain counters, but at the same time it is desirable not to waste connection resources if the flows are idle. Additionally, UDP flows are generally short (e.g., DNS or DHCP), but could also include long flows (e.g., used for streaming), therefore, such flows cannot be treated uniformly.

Therefore, embodiments of the present disclosure address at least some of the above drawbacks, by assigning new network flows to a “waiting pool” for an initial, short, time period (e.g., between 1 and 3 seconds, such as 2 seconds) based on the assumption that a high percentage (e.g., 80%) of network flows terminate in this time period. While the new network flows are assigned to the “waiting pool” the packets of the new network flows do not need to be counted by any counter. After the initial time period has elapsed, flows which have terminated connection status (e.g., terminated gracefully) (which should statistically be a very high percentage of the flows) can be ignored, while flows having a non-terminated connection status are observed for a second time period (e.g., between 1 and 5 seconds, such as 3 seconds) by assigning a per-flow packet counter to each of the flows having a non-terminated connection status to count packets flowing in each of the flows. The term “terminated connection status” is defined as the status of a network flow to which resources assigned to that flow have been released as the network flow has terminated explicitly. The term “non-terminated connection status” is defined as the status of a network flow to which resources are still assigned and the flow has not terminated explicitly, and that network flow may still be active or may have hung.

After the second time period, seemingly inactive flows (i.e., flows for which no packets were counted) are assigned among one or more “wait-to-die” pools (e.g., four flows may be assigned to each “wait-to-die” pool) such that any one flow is only assigned to one of the “wait-to-die” pools at a given time. Per-pool counters are established to count packets of the flows assigned to the “wait-to-die” pools for a third time period.

Active flows (i.e., flows for which a packet or packets have been counted) are added as a group to a “wait-and-watch” pool with a per-flow counter assigned to count packets of each flow assigned to the “wait-and-watch” pool for a fourth time period.

If the counter assigned to one of the “wait-to-die” pools has not changed in the third time period, resources associated with the flows assigned to that “wait-to-die” pool are released. If the counter assigned to that “wait-to-die” pool changes (e.g., increases) during the third time period, all the flows assigned to that “wait-to-die” pool are reassigned to per-flow packet counters for an additional time period, and the process described above is repeated.

The counter of each flow in the “wait-and-watch” pool is checked intermittently, and if any counter remains unchanged for a given time period, the resources associated with that flow are released.

A “network flow” is typically identified by the values of a specified set of header fields, such as the IP and TCP/UDP 5-tuple of source and destination addresses, source and destination ports, and protocol, or any suitable flow information such as layer 2, 3, 4 or tunnel data, which are consistent over all of the packets in the flow.

It should be noted that the embodiments of the present disclosure may reduce the number of counters assigned for counting flows while increasing the number of flows for which resources are assigned compared to the method where a counter is assigned to each flow.

### System Description

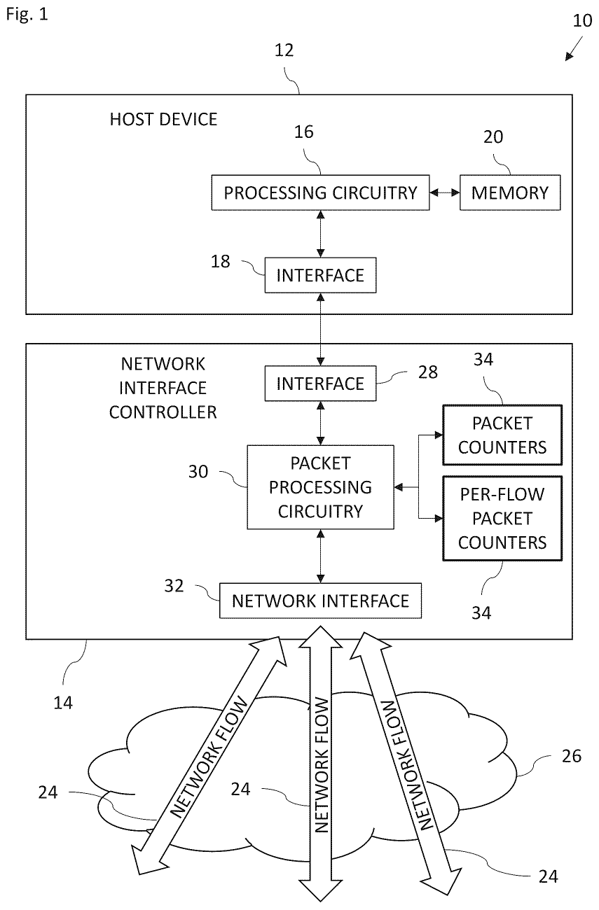

Reference is now made to FIG. 1, which is a block diagram view of a flow aging system 10 constructed and operative in accordance with an embodiment of the present disclosure. The system 10 includes a host device 12 and a network interface controller 14.

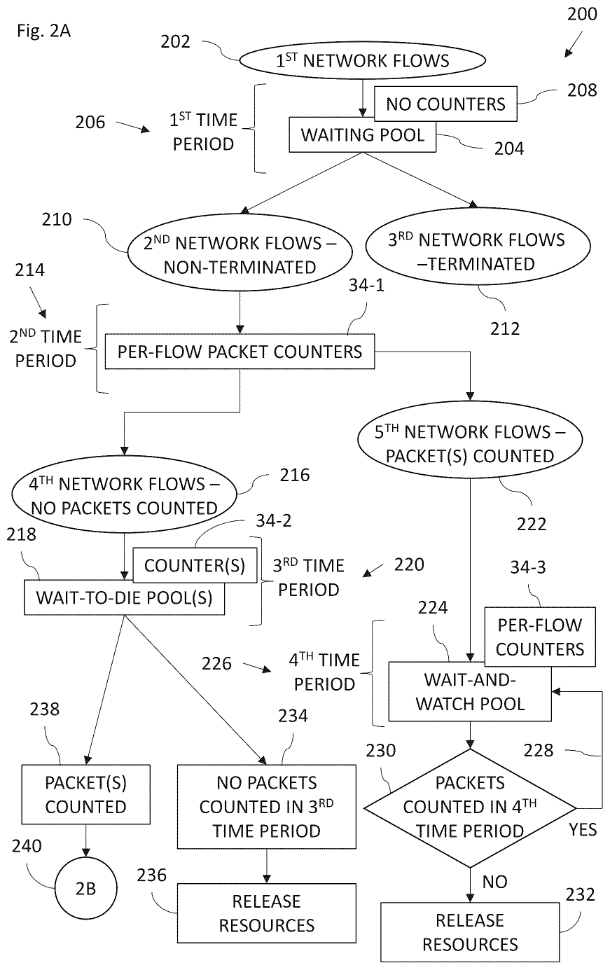

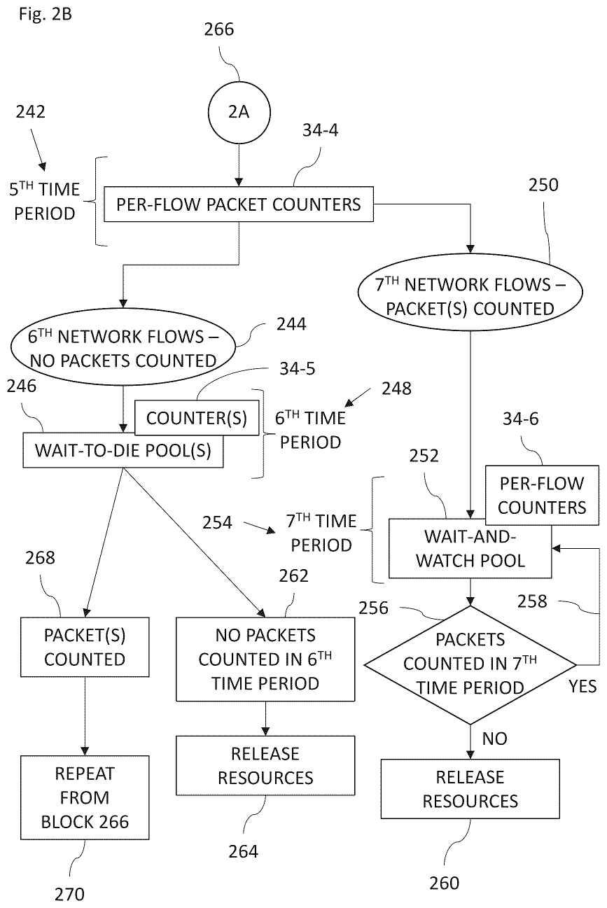

The host device 12 includes processing circuitry 16, an interface 18, a memory 20. The processing circuitry 16 may be implemented as a central processing unit (CPU) configured to execute software. The processing circuitry 16 is described in more detail with reference to FIGS. 2A-B. The interface 18 may be any suitable interface to share data with the network interface controller 14, for example a peripheral bus interface. The interface 18 may be configured to send and receive packets of network flows 24 over a network 26 via the network interface controller 14. The memory 20 is configured to stored data used by the processing circuitry 16.

The network interface controller 14 includes an interface 28, packet processing circuitry 30, and a network interface 32. The interface 28 may be any suitable interface to share data with the host device 12, for example a peripheral bus interface. The packet processing circuitry 30 is configured to process packets received over the network 26 and process packets to be sent over the network 26 via the network interface 32. The packet processing circuitry 30 may include a physical layer (PHY) chip (not shown) and a MAC chip (not shown). In some embodiments, the packet processing circuitry 30 is configured to maintain counters 34 used by the processing circuitry 16 to find idle network flows, described in more detail with reference to FIGS. 2A-B. The packet processing circuitry 30 is configured to update (e.g., increment or decrement) the counters 34 upon identifying packets of network flows assigned to the counters 34. For example, if network flow A is assigned to counter B, counter B may be incremented by the packet processing circuitry 30 when the packet processing circuitry 30 identifies a packet of network flow A being processed by the packet processing circuitry 30.

The processing circuitry 16 is configured to track a connection status of each of the network flows 24 and operate a flow aging process to identify idle network flows of the network flows 24 and release resources associated with the idle network flows, as described in more detail below.

In some embodiments, the functions performed by the processing circuitry 16 may be performed by any suitable processor or circuit(s) such as the packet processing circuitry 30 or another processor in the network interface controller 14 such as a data processing unit (DPU). The functions performed by the processing circuitry 16 may be performed by any suitable combination of processors and/or circuits in the host device 12 and/or the network interface controller 14 or in any other suitable device. For example, the processing circuitry 16 and/or the packet processing circuitry 30 and/or one or more other circuits may update counters 34. In some embodiments, the processing circuitry 16 (or any other processor or circuit(s) may configure the packet processing circuitry 30 or any other circuit(s) to create and/or maintain and/or update (e.g., increment or decrement) counters 34 and/or assign which of the network flows 24 should be packet-counted and whether some network flows 24 should be grouped to be packet-counted with a single counter or whether some network flows 24 should be packet-counted individually with per-flow counters 34. The term “packet-counted” is defined as counting packets of one or more network flows 24 to determine if a network flow is idle or active. The counters 34 are shown in FIG. 1 as being stored in network interface controller 14. In some embodiments, the counters 34 may be stored in the host device 12 such as in memory 20, or in any suitable device.

FIGS. 2A-B are views of a data flow diagram 200 illustrating an example method of operation of the system 10 of FIG. 1. The processing circuitry 16 is described below as performing many of the steps of the flow aging process. Any suitable circuit or circuits may perform any one or more of the steps of the flow aging process, instead of, or in addition to, the processing circuitry 16. In practice, some, or all of the functions of the processing circuitry 16 may be combined in a single physical component or, alternatively, implemented using multiple physical components. These physical components may comprise hard-wired or programmable devices, or a combination of the two. In some embodiments, at least some of the functions of the processing circuitry 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 2A.

In one stage of the flow aging process, the processing circuitry 16 is configured to assign first network flows 202 having a non-terminated connection status to a waiting pool 204 for a first time period 206. The number of the packets of the first network flows 202 assigned to the waiting pool 204 are not counted (block 208) during the first time period 206. At the end of the first time period 206, second network flows 210 (i.e., a subset of network flows) of the first network flows 202 have a non-terminated connection status, and third network flows 212 (i.e., another subset of network flows) of the first network flows 202 have a terminated connection status. The first time period 206 may have any suitable length. In some embodiment, the first time period 206 is between 1 and 3 seconds. The third network flows 212 are no longer relevant to the description below as they have terminated explicitly, and resources associated with them have been released.

In another stage of the flow aging process, after completion of the first time period 206, the processing circuitry 16 is configured to assign per-flow packet counters 34-1 (i.e., each network flow 210 is assigned its own counter 34-1 to count packets of that flow 210) to perform packet counting of the second network flows 210 for a second time period 214. The second time period 214 may be any suitable time period. In some embodiments, the second time period 214 is between 1 and 5 seconds.

The processing circuitry 16 is configured to identify fourth network flows 216 (i.e., a subset of network flows) of the second network flows 210 for which no packets have been counted by respective ones of the per-flow packet counters 34-1 during the second time period 214 starting from the time that the per-flow packet counters 34-1 were assigned to perform packet counting of the second network flows 210. The processing circuitry 16 is configured to: assign the fourth network flows 216 to one or more wait-to-die pools 218 with each flow being assigned to only one of the wait-to-die pools 218 for a given time period; and assign a per-pool packet counter 34-2 to perform packet counting of the fourth network flows 216 in the wait-to-die pools 218 for a third time period 220. In other words, any one of the per-pool packet counters 34-2 counts the packets of the flows (as a group) assigned to a corresponding one of the wait-to-die pools 218. In some embodiments, the processing circuitry 16 is configured to assign a maximum of four of the fourth network flows 216 to each wait-to-die pool 218.

The processing circuitry 16 is configured to identify at least one fifth network flow 222 (i.e., a subset of network flows) of the second network flows 210 for which one or more packets have been counted by respective ones of the per-flow packet counters 34-1 during the second time period 214 starting from the time that the per-flow packet counters 34-1 were assigned to perform packet counting of the second network flows 210. The processing circuitry 16 is configured to assign the fifth network flow(s) 222 to a wait-and-watch pool 224 and assign per-flow packet counters 34-3 (one counter for each fifth network flow 222) to perform packet counting of the fifth network flow(s) 222 during a fourth time period 226. The fourth time period 226 may be any suitable time period. For example, the fourth time period 226 may be between 3 and 20 seconds. The processing circuitry 16 is configured to examine each per-flow packet counter 34-3, and check if any packets have been counted by a given per-flow packet counter 34-3 in the fourth time period 226 (decision block 230). If one or more packets have been counted for a given fifth network flow 222 by the given per-flow packet counter 34-3 in the fourth time period 226, the given per-flow packet counter 34-3 is reset and assigned again to count the packets of the given fifth network flow 222 in the wait-and-watch pool 224 for a subsequent time period (e.g., equal to the fourth time period 226 or another suitable shorter or longer period) (arrow 228). If no packets have been counted by the given per-flow packet counter 34-3 in the fourth time period 226 (or subsequent time period), the processing circuitry 16 is configured to release resources associated with the given fifth network flow 222 (block 232) responsively to no packets being counted in the fourth time period 226 (or subsequent time period) by the given per-flow packet counter 34-3 assigned to perform packet counting of the given fifth network flow 222 of the wait-and-watch pool 224.

The description now returns to describe what happens to the fourth network flows 216 assigned to the wait-to-die pool(s) 218.

The processing circuitry 16 is configured to examine each per-pool packet counter 34-2. If no packets are counted in the third time period 220 by a given one of the per-pool packet counters 34-2 assigned to perform counting of the fourth network flows 216 of a given one the wait-to-die pools 218 (block 234), the processing circuitry 16 is configured to release resources associated with the fourth network flows 216 of the given wait-to-die pool 218 (block 236).

If the processing circuitry 16 identifies that one or more packets have been counted by the given per-pool packet counter 34-2 assigned to perform the packet counting of the fourth network flows 216 of the given wait-to-die pool 218 during the third time period 220 (block 238), the fourth network flows 216 of the given wait-to-die pool 218 are assigned to per-flow packet counters 34-4 as described in more detail with reference to FIG. 2B (block 240).

As shown on FIG. 2B starting from block 266, the processing circuitry 16 is configured to assign additional per-flow packet counters 34-4 (which could be the same as counters 34-1) to perform packet counting of the fourth network flows 216 for a fifth time period 242, responsively to identifying that one or more packets were counted by the given per-pool packet counter 34-2 assigned to perform the packet counting of the fourth network flows 216 of the given wait-to-die-pool 218. The fifth time period 242 may be any suitable time period, for example, between 1-3 seconds.

The processing circuitry 16 is configured to identify sixth network flows 244 (i.e., a subset of network flows) of the fourth network flows 216 for which no packets have been counted by respective ones of the additional per-flow packet counters 34-4 during the fifth time period 242 starting from a time that the additional per-flow packet counters 34-4 were assigned to perform packet counting of the fourth network flows 216. The processing circuitry 16 is configured to assign the sixth network flows 244 to another one or more wait-to-die pools 246 and assign one or more corresponding per-pool packet counters 34-5 to perform packet counting of the sixth network flows 244 for a sixth time period 248. The sixth time period 248 may be any suitable time period, for example, between 1 and 5 seconds.

The processing circuitry 16 is configured to identify at least one seventh network flow 250 (i.e., a subset of network flows) of the fourth network flows 216 for which one or more packets have been counted by respective ones of the additional per-flow packet counters 34-4 during the fifth time period 242 starting from the time that the additional per-flow packet counters 34-4 were assigned to perform the packet counting of the fourth network flows 216. The processing circuitry 16 is configured to assign the seventh network flow(s) 250 to a wait-and-watch pool 252 and assign per-flow packet counters 34-6 to perform packet counting of the seventh network flow(s) 250 for a seventh time period 254.

The seventh time period 254 may be any suitable time period. For example, the seventh time period 254 may be between 3 and 20 seconds. The processing circuitry 16 is configured to check if any packets have been counted by each of the per-flow packet counters 34-6 in the seventh time period 254 (decision block 256). If one or more packets have been counted by any per-flow packet counter 34-6 in the seventh time period 254, that per-flow packet counter 34-6 is reset and assigned again to count the packets of the seventh network flow 250 associated with that per-flow packet counter 34-6 in the wait-and-watch pool 252 for a subsequent time period (e.g., equal to the seventh time period 254 or another suitable shorter or longer time period) (arrow 258). If the no packets have been counted by any per-flow packet counter 34-6 in the seventh time period 254 (or subsequent time period), the processing circuitry 16 is configured to release resources associated with the seventh network flow 250 counted by that per-flow packet counter 34-6 (block 260).

The description now returns to describe what happens to the sixth network flows 244 assigned to the wait-to-die pool(s) 246.

If no packets are counted in the sixth time period 248 by any per-pool packet counter 34-5 assigned to perform counting of the sixth network flows 244 of a given one of the wait-to-die pools 246 (block 262), the processing circuitry 16 is configured to release resources associated with the sixth network flows 244 (block 264) of the given wait-to-die pool 246.

If the processing circuitry 16 identifies that one or more packets have been counted by any per-pool packet counter 34-5 assigned to perform the packet counting of given ones of the sixth network flows 244 of a given wait-to-die pool 246 during the sixth time period 248 (block 268), the given sixth network flows 244 may again be assigned to per-flow packet counters and the process described from block 266 may be repeated (block 270).

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
an interface to send and receive packets of a plurality of network flows; and
one or more circuits to:
track a connection status of each of the network flows;
operate a flow aging process to identify idle network flows of the network flows;
in one stage of the flow aging process, assign first network flows of the plurality of network flows having a non-terminated connection status to a waiting pool for a first time period, wherein at the end of the first time period second network flows of the first network flows have the non-terminated connection status, and third network flows of the first network flows have a terminated connection status;
in another stage of the flow aging process, after completion of the first time period, assign per-flow packet counters to perform packet counting of the second network flows; and
release resources associated with the idle network flows.

2. The system according to claim 1, wherein a number of the packets of the first network flows assigned to the waiting pool are not counted during the first time period.

3. The system according to claim 1, wherein the one or more circuits are to:
identify fourth network flows of the second network flows for which no packets have been counted by respective ones of the per-flow packet counters during a second time period starting from a time that the per-flow packet counters were assigned to perform the packet counting of the second network flows; and
assign the fourth network flows to a wait-to-die pool and assign a first per-pool packet counter to perform packet counting of the fourth network flows.

4. The system according to claim 3, wherein the one or more circuits are to assign only four of the fourth network flows to the wait-to-die pool.

5. The system according to claim 3, wherein the one or more circuits are to release resources associated with the fourth network flows responsively to no packets being counted in a given time period by the first per-pool packet counter assigned to perform packet counting of the fourth network flows of the wait-to-die pool.

6. The system according to claim 3, wherein the one or more circuits are to:
identify at least one fifth network flow of the second network flows for which at least one packet has been counted by respective ones of the per-flow packet counters during the second time period starting from the time that the per-flow packet counters were assigned to perform the packet counting of the second network flows; and
assign the at least one fifth network flow to a wait-and-watch pool and assign at least one second per-flow packet counter to perform packet counting of the at least one fifth network flow.

7. The system according to claim 6, wherein the one or more circuits is to release resources associated with a given flow of the at least one fifth network flow responsively to no packets being counted in a given time period by a given counter of the at least one second per-flow packet counter assigned to perform packet counting of the given flow of the at least one fifth network flow of the wait-and-watch pool.

8. The system according to claim 3, wherein the one or more circuits are to:
identify that at least one packet has been counted by the first per-pool packet counter assigned to perform the packet counting of the fourth network flows of the wait-to-die pool; and
assign additional per-flow packet counters to perform packet counting of the fourth network flows, responsively to identifying that the at least one packet has been counted by the first per-pool packet counter assigned to perform the packet counting of the fourth network flows of the wait-to-die-pool.

9. The system according to claim 8, wherein the one or more circuits are to:
identify sixth network flows of the fourth network flows for which no packets have been counted by respective ones of the additional per-flow packet counters during a third time period starting from a time that the additional per-flow packet counters were assigned to perform the packet counting of the fourth network flows; and
assign the sixth network flows to another wait-to-die pool and assign a third per-pool packet counter to perform packet counting of the sixth network flows.

10. The system according to claim 9, wherein the one or more circuits are to:
identify at least one seventh network flow of the fourth network flows for which at least one packet has been counted by respective ones of the additional per-flow packet counters during the third time period starting from the time that the additional per-flow packet counters were assigned to perform the packet counting of the fourth network flows; and
assign the at least one seventh network flow to a wait-and-watch pool and assign at least one per-flow fourth packet counter to perform packet counting of the at least one seventh network flow.

11. The system according to claim 3, wherein:
the first time period is between 1 and 3 seconds; and
the second time period is between 1 and 5 seconds.

12. A method, comprising:
sending and receiving packets of a plurality of network flows;
tracking a connection status of each of the network flows;
operating a flow aging process to identify idle network flows of the network flows;
in one stage of the flow aging process, assigning first network flows of the plurality of network flows having a non-terminated connection status to a waiting pool for a first time period, wherein at the end of the first time period second network flows of the first network flows have the non-terminated connection status, and third network flows of the first network flows have a terminated connection status;
in another stage of the flow aging process, after completion of the first time period, assigning per-flow packet counters to perform packet counting of the second network flows; and
releasing resources associated with the idle network flows.

13. The method according to claim 12, wherein a number of the packets of the first network flows assigned to the waiting pool are not counted during the first time period.

14. The method according to claim 12, further comprising:
identifying fourth network flows of the second network flows for which no packets have been counted by respective ones of the per-flow packet counters during a second time period starting from a time that the per-flow packet counters were assigned to perform the packet counting of the second network flows;
assigning the fourth network flows to a wait-to-die pool; and
assigning a first per-pool packet counter to perform packet counting of the fourth network flows.

15. The method according to claim 14, wherein the assigning the fourth network flows includes assigning only four of the fourth network flows to the wait-to-die pool.

16. The method according to claim 14, further comprising releasing resources associated with the fourth network flows responsively to no packets being counted in a given time period by the first per-pool packet counter assigned to perform packet counting of the fourth network flows of the wait-to-die pool.

17. The method according to claim 14, further comprising:
identifying at least one fifth network flow of the second network flows for which at least one packet has been counted by respective ones of the per-flow packet counters during the second time period starting from the time that the per-flow packet counters were assigned to perform the packet counting of the second network flows;
assigning the at least one fifth network flow to a wait-and-watch pool; and
assigning at least one second per-flow packet counter to perform packet counting of the at least one fifth network flow.

18. The method according to claim 17, further comprising releasing resources associated with a given flow of the at least one fifth network flow responsively to no packets being counted in a given time period by a given counter of the at least one second packet counter assigned to perform packet counting of the given flow of the at least one fifth network flow of the wait-and-watch pool.

19. The method according to claim 14, further comprising:
identifying that at least one packet has been counted by the first per-pool packet counter assigned to perform the packet counting of the fourth network flows of the wait-to-die pool; and
assigning additional per-flow packet counters to perform packet counting of the fourth network flows, responsively to identifying that the at least one packet has been counted by the first per-pool packet counter assigned to perform the packet counting of the fourth network flows of the wait-to-die-pool.

20. The method according to claim 19, further comprising:
identifying sixth network flows of the fourth network flows for which no packets have been counted by respective ones of the additional per-flow packet counters during a third time period starting from a time that the additional per-flow packet counters were assigned to perform the packet counting of the fourth network flows;
assigning the sixth network flows to another wait-to-die pool; and
assigning a third per-pool packet counter to perform packet counting of the sixth network flows.

21. The method according to claim 20, wherein the one or more circuits are to:
identifying at least one seventh network flow of the fourth network flows for which at least one packet has been counted by respective ones of the additional per-flow packet counters during the third time period starting from the time that the additional per-flow packet counters were assigned to perform the packet counting of the fourth network flows; and
assigning the at least one seventh network flow to a wait-and-watch pool; and
assigning a fourth per-flow packet counter to perform packet counting of the at least one seventh network flow.

22. The method according to claim 14, wherein:
the first time period is between 1 and 3 seconds; and
the second time period is between 1 and 5 seconds.
